(19) United States
(12) Patent Application Publication
(10) Pub. No.: US 2017/0225543 A1
(43) Pub. Date: Aug. 10, 2017

(54) EJECTOR-TYPE REFRIGERATION CYCLE

(71) Applicant: DENSO CORPORATION, Kariya-city, Aichi-pref. (JP)

(72) Inventors: Shun KURATA, Kariya-city (JP); Yoshiyuki YOKOYAMA, Kariya-city (JP); Youhei NAGANO, Kariya-city (JP); Haruyuki NISHIJIMA, Kariya-city (JP); Isamu TAKASUGI, Kariya-city (JP); Hiroshi KATAOKA, Kariya-city (JP)

(21) Appl. No.: 15/502,579

(22) PCT Filed: Aug. 7, 2015
(86) PCT No.: PCT/JP2015/003982

§ 371 Date: Feb. 8, 2017

(30) Foreign Application Priority Data
Aug. 28, 2014 (JP) 2014-173725
Jul. 8, 2015 (JP) 2015-136733

(51) Int. Cl. B60H 1/32

(52) U.S. Cl. CPC B60H 1/3204; B60H 1/323; B60H 2001/3297; B60H 2001/3298

(57) ABSTRACT

An ejector-type refrigeration cycle includes an ejector module integrated with a gas-liquid separation device. A length of a suction pipe that connects a gas-phase refrigerant outflow port of the ejector module to a suction port of a compressor is set to be shorter than a length of an outlet pipe that connects a refrigerant outflow port of an evaporator to a refrigerant suction port of the ejector module. A pressure loss that occurs when a refrigerant flows in the suction pipe may be set to be lower than a pressure loss that occurs when the refrigerant flows in an outlet pipe.

### CROSS REFERENCE TO RELATED APPLICATIONS

This application is based on and incorporates herein by reference Japanese Patent Applications No. 2014-173725 filed on Aug. 28, 2014, and No. 2015-136733 filed on Jul. 8, 2015.

### TECHNICAL FIELD

The present disclosure relates to an ejector-type refrigeration cycle having an ejector as a refrigerant depressurizing device.

### BACKGROUND ART

Up to now, an ejector-type refrigeration cycle that is a vapor compression refrigeration cycle device having an ejector as a refrigerant depressurizing device has been known.

In the ejector-type refrigeration cycle of this type, a refrigerant that has flowed out of an evaporator is drawn into a refrigerant suction port of the ejector by a suction action of an ejection refrigerant ejected at high speed from a nozzle portion of the ejector. A mixture refrigerant of the ejection refrigerant and the drawn refrigerant is increased in pressure by a diffuser portion (pressure increase portion) of the ejector, and then drawn into a compressor.

With the above configuration, in the ejector-type refrigeration cycle, a pressure of the drawn refrigerant can be increased more than the pressure of the drawn refrigerant in a normal refrigeration cycle device in which a refrigerant evaporation pressure in an evaporator is substantially equal to a pressure of the drawn refrigerant to be drawn into the compressor. Therefore, in the ejector-type refrigeration cycle, a coefficient of performance (COP) of the cycle can be improved with a reduction of a power consumption of the compressor.

Further, Patent Document 1 discloses an ejector (hereinafter referred to as “ejector module”) integrated with a gas-liquid separation device (gas-liquid separation portion).

According to the ejector module of Patent Document 1, a suction side of the compressor is connected to a gas-phase refrigerant outflow port, out of which a gas-phase refrigerant separated by the gas-liquid separation device flows. A refrigerant inflow port side of the evaporator is connected to a liquid-phase refrigerant outflow port, out of which a liquid-phase refrigerant separated by the gas-liquid separation device flows. Further, a refrigerant outflow port side of the evaporator is connected to the refrigerant suction port, thereby being capable of extremely easily configuring the ejector-type refrigeration cycle.

As described above, in the ejector-type refrigeration cycle, since a pressure of a drawn refrigerant is increased more than that in the general refrigeration cycle device, a density of the drawn refrigerant is increased, and a flow rate (mass flow rate) of the drawn refrigerant is likely to increase. For that reason, in the ejector-type refrigeration cycle, a pressure loss occurring when the drawn refrigerant flows in a suction pipe is likely to increase.

Further, the pressure loss is increased with an increase in a length of the suction pipe. Therefore, in the ejector-type refrigeration cycle, the degree of a reduction of the COP to the length of the suction pipe may be increased more than that in the general refrigeration cycle device. Incidentally, the suction pipe is a refrigerant pipe connected to the suction port of the compressor. For example, in Patent Document 1, the refrigerant pipe that connects the gas-phase refrigerant outflow port of the ejector module to the suction port of the compressor configures the suction pipe.

For that reason, an existing suction pipe used in the normal refrigeration cycle device is applied to the ejector-type refrigeration cycle of Patent Document 1 as it is, the refrigerant pressure immediately before suction of the refrigerant into the compressor may be decreased due to the pressure loss caused by the suction pipe. As a result, there is a risk that the COP improvement effect of the ejector-type refrigeration cycle described above cannot be sufficiently obtained.

### PRIOR ART DOCUMENT

### Patent Document

Patent Document 1: JP 2013-177879 A

### SUMMARY

In view of the above points, it is an object of the present disclosure to provide an ejector-type refrigeration cycle that is capable of sufficiently obtaining a COP improvement effect.

According to a first aspect of the present disclosure, an ejector-type refrigeration cycle includes a compressor, a radiator, an ejector module, an evaporator, a suction pipe and an outlet pipe. The compressor compresses and discharges a refrigerant. The radiator radiates heat of the refrigerant discharged from the compressor. The ejector module includes a body portion that includes: a nozzle portion which reduces a pressure of the refrigerant which has flowed out of the radiator; a refrigerant suction port which draws a refrigerant by a suction action of an ejection refrigerant ejected at high speed from the nozzle portion; a pressure increase portion which mixes the ejection refrigerant with a drawn refrigerant drawn from the refrigerant suction port and increases a pressure of the mixed refrigerant; a gas-liquid separation portion which separates the refrigerant that has flowed out of the pressure increase portion into gas and liquid; and a gas-phase refrigerant outflow port through which a gas-phase refrigerant separated by the gas-liquid separation portion flows out. The evaporator evaporates a liquid-phase refrigerant separated by the gas-liquid separation portion. The suction pipe connects the gas-phase refrigerant outflow port to a suction port of the compressor. The outlet pipe connects a refrigerant outflow port of the evaporator to the refrigerant suction port. The suction pipe and the outlet pipe have a configuration where a pressure loss that occurs in the refrigerant flowing through the suction pipe is smaller than a pressure loss that occurs in the refrigerant flowing through the outlet pipe.

According to the above configuration, since the pressure loss that occurs in the refrigerant flowing in the suction pipe is set to be smaller than the pressure loss that occurs in the refrigerant flowing in the outlet pipe, an effect to improve the COP of the ejector-type refrigeration cycle can be sufficiently obtained.

In more detail, the refrigerant that has flowed out of the refrigerant outflow port of the evaporator is drawn into the refrigerant suction port through the outlet pipe by the refrigerant suction action of the ejector module. Therefore, the flow rate (mass flow rate) of the refrigerant that flows in the outlet pipe is smaller than the flow rate (mass flow rate) of the refrigerant that flows in the suction pipe.

Therefore, the pressure loss that occurs in the refrigerant flowing in the suction pipe is set to be smaller than the pressure loss that occurs in the refrigerant flowing in the outlet pipe, thereby being capable of restraining significant decline in the refrigerant pressure immediately before suction of the refrigerant into the compressor. As a result, the effect to improve the COP of the ejector-type refrigeration cycle can be sufficiently obtained.

According to a second aspect of the present disclosure, an ejector-type refrigeration cycle includes a compressor, a radiator, an ejector module, an evaporator, a suction pipe and an outlet pipe. The compressor compresses and discharges a refrigerant. The radiator radiates heat of the refrigerant discharged from the compressor. The ejector module includes a body portion that includes: a nozzle portion which reduces a pressure of the refrigerant which has flowed out of the radiator; a refrigerant suction port which draws a refrigerant by a suction action of an ejection refrigerant ejected at high speed from the nozzle portion; a pressure increase portion which mixes the ejection refrigerant with a drawn refrigerant drawn from the refrigerant suction port and increases a pressure of the mixed refrigerant; a gas-liquid separation portion which separates the refrigerant that has flowed out of the pressure increase portion into gas and liquid; and a gas-phase refrigerant outflow port through which a gas-phase refrigerant separated by the gas-liquid separation portion flows out. The evaporator evaporates a liquid-phase refrigerant separated by the gas-liquid separation portion. The suction pipe connects the gas-phase refrigerant outflow port to a suction port of the compressor. The outlet pipe connects a refrigerant outflow port of the evaporator to the refrigerant suction port. A length of the suction pipe is shorter than a length of the outlet pipe.

According to the above configuration, since the length of the suction pipe is shorter than the length of the outlet pipe, the pressure loss that occurs in the refrigerant flowing in the suction pipe can be easily set to be smaller than the pressure loss that occurs in the refrigerant flowing in the outlet pipe. Therefore, as in the above first aspect, the effect to improve the COP of the ejector-type refrigeration cycle can be sufficiently obtained.

In this example, the “length of the pipe” may employ a total length of a center line of the pipe having a straight shape or a curved shape. Therefore, the “length of the pipe” can be expressed as a “flow channel length”. In addition, the “pipe” is not limited to a tubular member, but includes a member providing a flow channel in which the refrigerant flows, which is formed in shapes other than the tubular shape (for example, block-shaped member, joint-shaped member).

According to a third aspect of the present disclosure, an ejector-type refrigeration cycle includes a compressor, a radiator, a branch portion, a first ejector module, a first evaporator, a second ejector module, a second evaporator, a first suction pipe, a first outlet pipe, a second suction pipe, a second outlet pipe, a first inlet pipe and a second inlet pipe. The compressor compresses and discharges a refrigerant. The radiator radiates heat of the refrigerant discharged from the compressor. The branch portion branches a flow of the refrigerant that has flowed out of the radiator. The first ejector module includes a first body portion that includes: a first nozzle portion that reduces a pressure of one refrigerant branched by the branch portion; a first refrigerant suction port that draws a refrigerant by a suction action of a first ejection refrigerant ejected at high speed from the first nozzle portion; a first pressure increase portion that mixes the first ejection refrigerant with a first drawn refrigerant drawn from the first refrigerant suction port and increases a pressure of the mixed refrigerant; a first gas-liquid separation portion that separates the refrigerant that has flowed out of the first pressure increase portion into gas and liquid; a first gas-phase refrigerant outflow port through which a gas-phase refrigerant separated by the first gas-liquid separation portion flows out; and a first liquid-phase refrigerant outflow port through which a liquid-phase refrigerant separated by the first gas-liquid separation portion flows out. The first evaporator evaporates the liquid-phase refrigerant separated by the first gas-liquid separation portion. The second ejector module includes a second body portion that includes: a second nozzle portion that reduces a pressure of another refrigerant branched by the branch portion; a second refrigerant suction port that draws a refrigerant by a suction action of a second ejection refrigerant ejected at high speed from the second nozzle portion; a second pressure increase portion that mixes the second ejection refrigerant with a second drawn refrigerant drawn from the second refrigerant suction port and increases a pressure of the mixed refrigerant; a second gas-liquid separation portion that separates the refrigerant that has flowed out of the second pressure increase portion into gas and liquid; and a second gas-phase refrigerant outflow port through which a gas-phase refrigerant separated by the second gas-liquid separation portion flows out; and a second liquid-phase refrigerant outflow port through which a liquid-phase refrigerant separated by the second gas-liquid separation portion flows out. The second evaporator evaporates the liquid-phase refrigerant separated by the second gas-liquid separation portion. The first suction pipe connects the first gas-phase refrigerant outflow port to a suction port of the compressor. The first outlet pipe connects a refrigerant outflow port of the first evaporator to the first refrigerant suction port. The second suction pipe connects the second gas-phase refrigerant outflow port to the suction port of the compressor. The second outlet pipe connects a refrigerant outflow port of the second evaporator to the second refrigerant suction port. The first inlet pipe connects the first liquid-phase refrigerant outflow port to a refrigerant inflow port of the first evaporator. The second inlet pipe connects the second liquid-phase refrigerant outflow port to a refrigerant inflow port of the second evaporator. The first suction pipe and the first outlet pipe have a configuration where a pressure loss that occurs in the refrigerant flowing through the first suction pipe to be smaller than a pressure loss that occurs in the refrigerant flowing through the first outlet pipe. The second suction pipe and the second outlet pipe have a configuration where a pressure loss that occurs in the refrigerant flowing through the second suction pipe to be smaller than a pressure loss that occurs in the refrigerant flowing through the second outlet pipe. At least one of the first outlet pipe and the second outlet pipe includes an outer pipe of a double pipe. At least one of the first inlet pipe and the second inlet pipe includes an inner pipe of the double pipe.

According to the above configuration, a cycle in which the first evaporator and the second evaporator are connected in parallel to the compressor can be configured, and thus the first and second evaporators are capable of cooling different fluids separately.

Further, the pressure loss that occurs in the refrigerant flowing in the first suction pipe is set to be smaller than the pressure loss that occurs in the refrigerant flowing in the first outlet pipe, and the pressure loss that occurs in the refrigerant flowing in the second suction pipe is set to be smaller than the pressure loss that occurs in the refrigerant flowing in the second outlet pipe. Therefore, as in the above first aspect, the effect to improve the COP of the ejector-type refrigeration cycle can be sufficiently obtained.

In addition, at least one of the first outlet pipe and the second outlet pipe includes an outer pipe of a double pipe, and at least one of the first inlet pipe and the second inlet pipe includes an inner pipe of the double pipe.

Therefore, at least one of the refrigerants that flow into the first and second evaporators can be restrained from absorbing a heat from an outside air and increasing an enthalpy. As a result, a reduction in a refrigeration capacity exerted on at least one of the first and second evaporators can be suppressed.

In this example, the “double pipe” represents a pipe that includes two pipes different in diameter from each other in which an inner pipe smaller in diameter is disposed inside of an outer pipe larger in diameter. Therefore, in the “double pipe”, respective flow channels are provided on an inner peripheral side of the inner pipe and provided between an inner peripheral side of the outer pipe and an outer peripheral side of the inner pipe. The fluids (refrigerants) flow in the respective flow paths.

According to a fourth aspect of the present disclosure, an ejector-type refrigeration cycle includes a compressor, a radiator, a branch portion, a first ejector module, a first evaporator, a second ejector module, a second evaporator, a first suction pipe, a first outlet pipe, a second suction pipe, a second outlet pipe, a first inlet pipe and a second inlet pipe. The compressor compresses and discharges a refrigerant. The radiator radiates heat of the refrigerant discharged from the compressor. The branch portion branches a flow of the refrigerant that has flowed out of the radiator. The first ejector module includes a first body portion that includes: a first nozzle portion that reduces a pressure of one refrigerant branched by the branch portion; a first refrigerant suction port that draw a refrigerant by a suction action of a first ejection refrigerant ejected at high speed from the first nozzle portion; a first pressure increase portion that mixes the first ejection refrigerant with a first drawn refrigerant drawn from the first refrigerant suction port and increases a pressure of the mixed refrigerant; a first gas-liquid separation portion that separates the refrigerant that has flowed out of the first pressure increase portion into gas and liquid; a first gas-phase refrigerant outflow port through which a gas-phase refrigerant separated by the first gas-liquid separation portion flows out; and a first liquid-phase refrigerant outflow port through which a liquid-phase refrigerant separated by the first gas-liquid separation portion flows out. The first evaporator evaporates the liquid-phase refrigerant separated by the first gas-liquid separation portion. The second ejector module includes a second body portion that includes: a second nozzle portion that reduces a pressure of another refrigerant branched by the branch portion; a second refrigerant suction port that draws the refrigerant by a suction action of a second ejection refrigerant ejected at high speed from the second nozzle portion; a second pressure increase portion that mixes the second ejection refrigerant with a second drawn refrigerant drawn from the second refrigerant suction port and increases a pressure of the mixed refrigerant; a second gas-liquid separation portion that separates the refrigerant that has flowed out of the second pressure increase portion into gas and liquid; and a second gas-phase refrigerant outflow port through which a gas-phase refrigerant separated by the second gas-liquid separation portion flows out; and a second liquid-phase refrigerant outflow port through which a liquid-phase refrigerant separated by the second gas-liquid separation portion flows out. The second evaporator evaporates the liquid-phase refrigerant separated by the second gas-liquid separation portion. The first suction pipe connects the first gas-phase refrigerant outflow port to a suction port of the compressor. The first outlet pipe connects a refrigerant outflow port of the first evaporator to the first refrigerant suction port. The second suction pipe connects the second gas-phase refrigerant outflow port to the suction port of the compressor. The second outlet pipe connects a refrigerant outflow port of the second evaporator to the second refrigerant suction port. The first inlet pipe connects the first liquid-phase refrigerant outflow port to a refrigerant inflow port of the first evaporator. The second inlet pipe connects the second liquid-phase refrigerant outflow port to a refrigerant inflow port of the second evaporator. A length of the first suction pipe is set to be shorter than a length of the first outlet pipe. A length of the second suction pipe is set to be shorter than a length of the second outlet pipe. At least one of the first outlet pipe and the second outlet pipe includes an outer pipe of a double pipe. At least one of the first inlet pipe and the second inlet pipe includes an inner pipe of the double pipe.

According to the above configuration, as in the above third aspect, different fluids can be cooled by the first and second evaporators separately.

Further, the length of the first suction pipe is shorter than the length of the first outlet pipe, and the length of the second suction pipe is shorter than the length of the second outlet pipe.

Therefore, the pressure loss that occurs in the refrigerant flowing in the first suction pipe can be easily set to be smaller than the pressure loss that occurs in the refrigerant flowing in the first outlet pipe, and the pressure loss that occurs in the refrigerant flowing in the second suction pipe can be easily set to be smaller than the pressure loss that occurs in the refrigerant flowing in the second outlet pipe.

As a result, as in the above third aspect, the effect to improve the COP of the ejector-type refrigeration cycle can be sufficiently obtained.

In addition, at least one of the first outlet pipe and the second outlet pipe includes an outer pipe of a double pipe, and at least one of the first inlet pipe and the second inlet pipe includes an inner pipe of the double pipe. Therefore, as in the third embodiment, a reduction in the refrigeration capacity exerted on at least one of the first and second evaporators can be suppressed.

### BRIEF DESCRIPTION OF THE DRAWINGS

FIG. 1 is a schematic diagram of an ejector-type refrigeration cycle according to a first embodiment of the present disclosure.

FIG. 2 is a diagram illustrating a relationship between a pipe length ratio (Ls/Lo) and a cycle efficiency (COP) in the ejector-type refrigeration cycle according to the first embodiment.

FIG. 3 is a schematic diagram of an ejector-type refrigeration cycle according to a second embodiment of the present disclosure.

FIG. 4 is a schematic diagram of an ejector-type refrigeration cycle according to a third embodiment of the present disclosure.

### DESCRIPTION OF EMBODIMENTS

Hereinafter, multiple embodiments for implementing the present invention will be described referring to drawings. In the respective embodiments, a part that corresponds to a matter described in a preceding embodiment may be assigned the same reference numeral, and redundant explanation for the part may be omitted. When only a part of a configuration is described in an embodiment, another preceding embodiment may be applied to the other parts of the configuration. The parts may be combined even if it is not explicitly described that the parts can be combined. The embodiments may be partially combined even if it is not explicitly described that the embodiments can be combined, provided there is no harm in the combination.

### First Embodiment

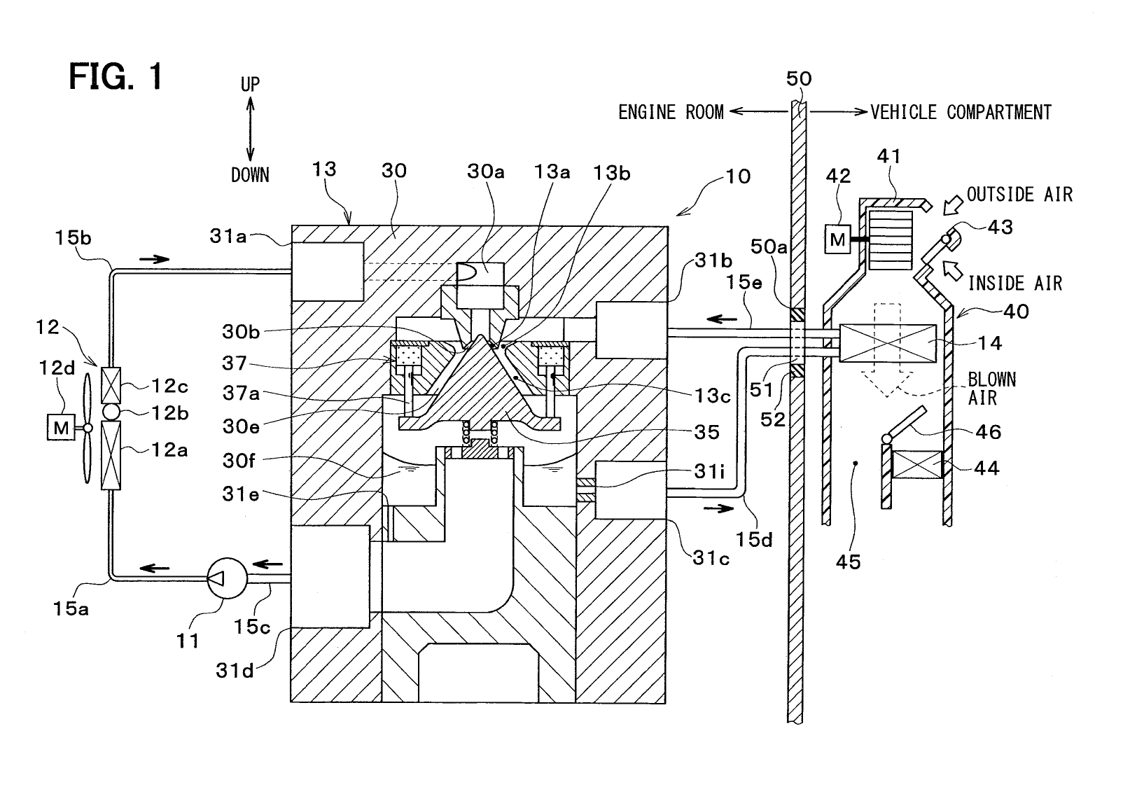

A first embodiment of the present disclosure will be described below with reference to the drawings. An ejector-type refrigeration cycle 10 according to the present embodiment, which is illustrated in an overall configuration diagram of FIG. 1, is applied to a vehicle air conditioning apparatus, and performs a function of cooling a blown air to be blown into a vehicle compartment (vehicle interior space) that is an air-conditioning target space. Therefore, the cooling target fluid in the ejector-type refrigeration cycle 10 is the blown air.

The ejector-type refrigeration cycle 10 employs an HFC based refrigerant (specifically, R134a) as the refrigerant, and forms a subcritical refrigeration cycle in which a high-pressure side refrigerant pressure does not exceed a critical pressure of the refrigerant. The refrigeration cycle 10 may employ an HFO based refrigerant (specifically, R1234yf) or the like as the refrigerant. Furthermore, refrigerator oil for lubricating a compressor 11 is mixed in the refrigerant, and a part of the refrigerator oil circulates in the cycle together with the refrigerant.

The compressor 11 that is one configuration equipment of the ejector-type refrigeration cycle 10 draws the refrigerant, pressurizes the refrigerant to a high-pressure refrigerant, and discharges the refrigerant. The compressor 11 is disposed in an engine room together with an internal combustion engine (engine) not shown which outputs a vehicle traveling driving force. The compressor 11 is driven by a rotational driving force output from the engine through a pulley, a belt, and the like.

In more detail, in the present embodiment, the compressor 11 employs a variable capacity type compressor that is configured so that a refrigerant discharge capacity can be adjusted by changing a discharge volume. The discharge capacity (refrigerant discharge capacity) of the compressor 11 is controlled according to a control current to be output to a discharge capacity control valve of the compressor 11 from a control device to be described later.

Incidentally, the engine room in the present embodiment is a vehicle exterior space in which the engine is housed, which is surrounded by a vehicle body, a fire wall 50 to be described later, and so on. The engine room may be also called “engine compartment”. A discharge port of the compressor 11 is connected with a refrigerant inflow port of a condensing portion 12a of a radiator 12 through an upstream side high-pressure pipe 15a.

The radiator 12 is a radiation heat exchanger that performs a heat exchange between the high-pressure refrigerant discharged from the compressor 11 and a vehicle exterior air (outside air) blown by a cooling fan 12d to radiate the heat from the high-pressure refrigerant and cool the high-pressure refrigerant. The radiator 12 is disposed on a front side of the vehicle in the engine room.

More specifically, the radiator 12 according to the present embodiment is configured as a so-called subcooling condenser including the condensing portion 12a, a receiver portion 12b, and a subcooling portion 12c. The condensing portion 12a performs the heat exchange between a high-pressure gas-phase refrigerant discharged from the compressor 11 and an outside air blown from the cooling fan 12d, and radiates the heat from the high pressure gas-phase refrigerant to condense the high pressure gas-phase refrigerant. The receiver portion 12b separates gas and liquid of the refrigerant that has flowed out of the condensing portion 12a and stores an excess liquid-phase refrigerant. The subcooling portion 12c performs the heat exchange between the liquid-phase refrigerant that has flowed out of the receiver portion 12b and the outside air blown from the cooling fan 12d and subcools the liquid-phase refrigerant.

The cooling fan 12d is an electric blower, a rotating speed (the blown air amount) of which is controlled by a control voltage output from the control device. A refrigerant inflow port 31a of an ejector module 13 is connected to a refrigerant outflow port of the subcooling portion 12c of the radiator 12 through a downstream side high-pressure pipe 15b.

The ejector module 13 functions as a refrigerant depressurizing device for reducing a pressure of the high pressure liquid-phase refrigerant of the subcooling state, which has flowed out of the radiator 12, and allowing the refrigerant to flow to the downstream side. The ejector module 13 also functions as a refrigerant circulating device (refrigerant transport device) for suctioning (transporting) the refrigerant that has flowed out of an evaporator 14 to be described later by the suction action of a refrigerant flow ejected at high speed to circulate the refrigerant. Further, the ejector module 13 according to the present embodiment functions as a gas-liquid separation device for separating the pressure-reduced refrigerant into gas and liquid.

In other words, the ejector module 13 according to the present embodiment is configured as an “ejector integrated with a gas-liquid separation device” or an “ejector with a gas-liquid separation function”. In the present embodiment, in order to clarify a difference from an ejector having no gas-liquid separation device (gas-liquid separation portion), a configuration in which the ejector is integrated (modularized) with the gas-liquid separation device is expressed by a term of “ejector module”.

The ejector module 13 is disposed in the engine room together with the compressor 11 and the radiator 12. Incidentally, respective up and down arrows in FIG. 1 indicate up and down directions in a state where the ejector module 13 is mounted in the vehicle, and the respective up and down directions in a state where other components are mounted in the vehicle are not limited to the above arrows.

In more detail, as illustrated in FIG. 1, the ejector module 13 according to the present embodiment includes a body portion 30 configured by the combination of multiple components. The body portion 30 is made of prismatic or cylindrical metal or plastic. The body portion 30 is provided with multiple refrigerant inflow ports and multiple internal spaces.

The multiple refrigerant inflow and outflow ports provided in the body portion 30 include a refrigerant inflow port 31a, a refrigerant suction port 31b, a liquid-phase refrigerant outflow port 31c, a gas-phase refrigerant outflow port 31d, and so on. The refrigerant inflow port 31a allows the refrigerant that has flowed out of the radiator 12 to flow into the body portion 30. The refrigerant suction port 31b draws the refrigerant that has flowed out of the evaporator 14. The liquid-phase refrigerant outflow port 31c allows the liquid-phase refrigerant separated by a gas-liquid separation space 30f provided in the body portion 30 to flow to the refrigerant inlet side of the evaporator 14. The gas-phase refrigerant outflow port 31d allows the gas-phase refrigerant separated by the gas-liquid separation space 30f to flow to the suction side of the compressor 11.

The internal space provided in the body portion 30 includes a swirling space 30a, a depressurizing space 30b, a pressurizing space 30e, the gas-liquid separation space 30f, and so on. The swirling space 30a swirls the refrigerant that has flowed from the refrigerant inflow port 31a. The depressurizing space 30b reduces the pressure of the refrigerant that has flowed out of the swirling space 30a. The pressurizing space 30e allows the refrigerant that has flowed out of the depressurizing space 30b to flow into the pressurizing space 30e. The gas-liquid separation space 30f separates the refrigerant that has flowed out of the pressurizing space 30e into gas and liquid.

The swirling space 30a and the gas-liquid separation space 30f are each shaped into a substantially cylindrical rotating body. The depressurizing space 30b and the pressurizing space 30e are each shaped into a substantially truncated cone-shaped rotating body that gradually expands toward the gas-liquid separation space 30f side from the swirling space 30a side. All of the center axes of those spaces are disposed coaxially. Incidentally, the rotating body represents a three-dimensional shape provided when rotating a plane figure around one straight line (center axis) on the same plane.

Further, the body portion 30 is provided with a suction passage 13b, and the suction passage 13b introduces the refrigerant drawn from the refrigerant suction port 31b to a downstream side of the depressurizing space 30b in the refrigerant flow and an upstream side of the pressurizing space 30e in the refrigerant flow.

A passage formation member 35 is disposed in the depressurizing space 30b and the pressurizing space 30e. The passage formation member 35 is formed in an approximately cone shape which gradually expands more toward an outer peripheral side with distance from the depressurizing space 30b, and a center axis of the passage formation member 35 is also disposed coaxially with the center axis of the depressurizing space 30b and so on.

A refrigerant passage is provided between an inner peripheral surface of a portion providing the depressurizing space 30b and the pressurizing space 30e of the body portion 30 and a conical side surface of the passage formation member 35. A shape of an axial vertical cross-section of the refrigerant passage is annular (a donut shape in which a small-diameter circular shape coaxially disposed is removed from a circular shape).

In the above refrigerant passage, a refrigerant passage provided between a portion providing the depressurizing space 30b of the body portion 30 and a portion of the conical side surface of the passage formation member 35 on an apex side is shaped to narrow a passage cross-sectional area toward a refrigerant flow downstream side. With that shape, the refrigerant passage configures a nozzle passage 13a that functions as a nozzle portion which reduces the pressure of the refrigerant in an isentropic manner and ejects the refrigerant.

In more detail, the nozzle passage 13a according to the present embodiment is shaped to gradually reduce a passage cross-sectional area toward a minimum passage area portion from an inlet side of the nozzle passage 13a, and gradually expand the passage cross-sectional area from the minimum passage area portion toward an outlet side of the nozzle passage 13a. In other words, in the nozzle passage 13a according to the present embodiment, the refrigerant passage cross-sectional area is changed as in a so-called “Laval nozzle”.

A refrigerant passage provided between a portion forming the pressurizing space 30e of the body portion 30 and a downstream portion of the conical side surface of the passage formation member 35 is shaped to gradually expand the passage cross-sectional area toward the refrigerant flow downstream side. With that configuration, the refrigerant passage configures a diffuser passage 13c functioning as a diffuser portion (pressure increase portion) which mixes an ejection refrigerant ejected from the nozzle passage 13a with a drawn refrigerant drawn from refrigerant suction port 31b to increase the pressure.

An element 37 functioning as a drive device for displacing the passage formation member 35 to change the passage cross-sectional area of the minimum passage area portion of the nozzle passage 13a is disposed in the body portion 30. In more detail, the element 37 has a diaphragm that is displaced according to a temperature and a pressure of the refrigerant (that is, refrigerant flowing out of the evaporator 14) which flows in the suction passage 13b. The displacement of the diaphragm is transferred to the passage formation member 35 through an actuating bar 37a, to thereby displace the passage formation member 35 in a vertical direction.

Further, with increase in the temperature (the degree of superheat) of the refrigerant flowing out of the evaporator 14, the element 37 displaces the passage formation member 35 in a direction of expanding the passage cross-sectional area of the minimum passage area portion (toward the lower side in the vertical direction). On the other hand, with a decrease in the temperature (the degree of superheat) of the refrigerant flowing out of the evaporator 14, the element 37 displaces the passage formation member 35 in a direction of reducing the passage cross-sectional area of the minimum passage area portion (toward the upper side in the vertical direction).

In the present embodiment, the element 37 displaces the passage formation member 35 according to the degree of superheating of the refrigerant flowing out of the evaporator 14 as described above. As a result, the passage cross-sectional area of the minimum passage area portion of the nozzle passage 13a is adjusted so that the degree of superheat of the refrigerant present on the outlet side of the evaporator 14 comes closer to a predetermined reference degree of superheat.

The gas-liquid separation space 30f is disposed on a lower side of the passage formation member 35. The gas-liquid separation space 30f configures a gas-liquid separation portion of a centrifugation type which swirls the refrigerant that has flowed out of the diffuser passage 13c around a center axis and separates gas and liquid of the refrigerant by the action of a centrifugal force. Further, the gas-liquid separation space 30f has an internal capacity insufficient to substantially accumulate an excessive refrigerant even if a load is varied in the cycle, and the refrigerant circulation flow rate that is circulated in the cycle is varied.

In addition, an oil return hole 31e is provided in a portion defining a bottom surface of the gas-liquid separation space 30f in the body portion 30. The oil return hole 31e returns the refrigerator oil in the separated liquid-phase refrigerant to a gas-phase refrigerant passage side that connects the gas-liquid separation space 30f to the gas-phase refrigerant outflow port 31d. In addition, an orifice 31i as the depressurizing device is disposed in the liquid-phase refrigerant passage that connects the gas-liquid separation space 30f to the liquid-phase refrigerant outflow port 31c. The orifice 31i functions as a pressure reducing device for reducing the pressure of the refrigerant that is allowed to flow into the evaporator 14.

The gas-phase refrigerant outflow port 31d of the ejector module 13 is connected with a suction port of the compressor 11 through a suction pipe 15c. On the other hand, the liquid-phase refrigerant outflow port 31c is connected with a refrigerant inflow port of the evaporator 14 through the inlet pipe 15d.

The evaporator 14 is a heat-absorbing heat exchanger that performs a heat exchange between the low-pressure refrigerant depressurized by the ejector module 13 and the blown air that is blown into the vehicle compartment from a blower 42, to thereby evaporate the low-pressure refrigerant and exert a heat absorbing effect. Further, the evaporator 14 is disposed in a casing 41 of a vehicle interior air conditioning unit 40 to be described later.

In this example, the vehicle of the present embodiment is equipped with a fire wall 50 as a partition plate that partitions the vehicle into the vehicle compartment and the engine room outside the vehicle compartment. The fire wall 50 has a function of reducing a heat, noise, and so on to be transferred from the engine room to the vehicle compartment, and may be called “dash panel”.

As illustrated in FIG. 1, the vehicle interior air conditioning unit 40 is disposed on the vehicle compartment side with respect to the fire wall 50. Therefore, the evaporator 14 is disposed in the vehicle compartment (vehicle interior space). The refrigerant outflow port of the evaporator 14 is connected with the refrigerant suction port 31b of the ejector module 13 through an outlet pipe 15e.

In this example, since the ejector module 13 is disposed in the engine room (vehicle exterior space) as described above, the inlet pipe 15d and the outlet pipe 15e are disposed to penetrate through the fire wall 50.

In more detail, the fire wall 50 is provided with a circular or rectangular through hole 50a that penetrates between the engine room side and the vehicle compartment (vehicle interior space) side. The inlet pipe 15d and the outlet pipe 15e are connected to a connector 51 and integrated together. The inlet pipe 15d and the outlet pipe 15e are disposed to penetrate through the through hole 50a in a state where the inlet pipe 15d and the outlet pipe 15e are integrated together by the connector 51.

In this situation, the connector 51 is located on an inner peripheral side or in the vicinity of the through hole 50a. A packing 52 made of an elastic member is disposed in a gap provided between an outer peripheral side of the connector 51 and an opening edge of the through hole 50a. In the present embodiment, the packing 52 is made of ethylene propylene diene copolymer rubber (EPDM) that is a rubber material excellent in heat resistance.

With the interposition of the packing 52 in the gap provided between the connector 51 and the through hole 50a, water, noise, and so on are restrained from being leaked into the vehicle compartment from the engine room through the gap provided between the connector 51 and the through hole 50a.

Further, in the ejector-type refrigeration cycle 10 of the present embodiment, respective pipe diameters (passage cross-sectional area) of a suction pipe 15c, the inlet pipe 15d, and the outlet pipe 15e in which a low-pressure refrigerant flows are larger than pipe diameters (passage cross-sectional area) of the upstream side high-pressure pipe 15a and the downstream side high-pressure pipe 15b in which a high-pressure refrigerant flows. In addition, the suction pipe 15c, the inlet pipe 15d, and the outlet pipe 15e are equal in the pipe diameter (passage cross-sectional area) to each other.

A length of the suction pipe 15c is set to be longer than a length of the outlet pipe 15e. A pressure loss that occurs when the refrigerant flows in the suction pipe 15c is set to be lower than a pressure loss that occurs when the refrigerant flows in an outlet pipe 15e. Further, the length of the suction pipe 15c according to the present embodiment is equal to or shorter than 10 m (meter) like a length of the suction pipe for the normal refrigeration cycle device used in a general vehicle air conditioning apparatus.

In this example, the length of the pipe in the present embodiment is a total length of a center line of the pipe shaped into a straight line or a curved line. Therefore, the length of the pipe can be expressed as a flow channel length. In addition, the pipe in the present embodiment is not limited to a tubular member, but includes a member providing a flow channel in which the refrigerant flows, which is formed in shapes other than the tubular shape as with the connector 51.

Further, the length of the outlet pipe 15e according to the present embodiment is a length of the pipe extending from the refrigerant outflow port of the evaporator 14 to the refrigerant suction port 31b of the ejector module 13, but not a length of the pipe extending from the connector 51 to the refrigerant suction port 31b of the ejector module 13.

Subsequently, the vehicle interior air conditioning unit 40 will be described. The vehicle interior air conditioning unit 40 is used to blow the blown air, the temperature of which has been adjusted by the ejector-type refrigeration cycle 10, into the vehicle compartment. The vehicle interior air conditioning unit 40 is disposed inside a dashboard (instrument panel) positioned at the foremost portion in the vehicle compartment. Moreover, the vehicle interior air conditioning unit 40 is configured so that the blower 42, the evaporator 14, a heater core 44, an air mixture door 46, and so on are housed in the casing 41 forming an outer shell of the vehicle interior air conditioning unit 40.

The casing 41 is provided with an air passage for the blown air to be blown into the vehicle compartment, and is made of a resin (for example, polypropylene) that has a certain degree of elasticity and is also excellent in terms of strength. An inside and outside air switching device 43 is disposed on a most upstream side of the blown air flow in the casing 41 as an inside and outside air switching unit that switchably introduces the inside air (vehicle interior air) and the outside air (vehicle exterior air) into the casing 41.

The inside and outside air switching device 43 continuously adjusts opening areas of an inside air introduction port for introducing the inside air into the casing 41, and an outside air introduction port for introducing the outside air into the casing 41 by an inside and outside air switching door to continuously change an air volume ratio of an inside air volume and an outside air volume. The inside and outside air switching door is driven by an electric actuator for the inside and outside air switching door, and the electric actuator is controlled in operation according to a control signal output from the control device.

The blower 42 is disposed on the blown air flow downstream side of the inside and outside air switching device 43. The blower 42 functions as a blowing device that blows the air taken through the inside and outside air switching device 43 toward the vehicle compartment. The blower 42 is an electric blower that drives a centrifugal multi-blade fan (sirocco fan) with the help of an electric motor, and is controlled in rotation speed (blown air amount) according to a control voltage output from the control device.

The evaporator 14 and the heater core 44 are disposed on the air flow downstream side of the blower 42, in the stated order along a flow of the blown air. In other words, the evaporator 14 is disposed on the blown air flow upstream side than the heater core 44. The heater core 44 is a heating heat exchanger that exchanges heat between an engine coolant and the blown air that has passed through the evaporator 14, and heats the blown air.

Further, a cold air bypass passage 45 is provided in the casing 41. The cold air bypass passage 45 allows the blown air having passed through the evaporator 14 to bypass the heater core 44 and flow to the downstream side. The air mixture door 46 is disposed on the blown air flow downstream side of the evaporator 14 and on the blown air flow upstream side of the heater core 44.

The air mixture door 46 is an air volume ratio adjusting device that adjusts an air volume ratio of an air passing through the heater core 44 and an air passing through the cold air bypass passage 45 in the air that has passed through the evaporator 14. The air mixture door 46 is driven by an electric actuator for driving the air mixture door, and the electric actuator is controlled in operation according to the control signal output from the control device.

A mixing space is provided on the downstream side of the heater core 44 in the air flow and on the air flow downstream side of the cold air bypass passage 45. The mixing space allows the air that has passed through the heater core 44 and the air that has passed through the cold air bypass passage 45 to be mixed together. Therefore, the air mixture door 46 adjusts an air volume ratio to adjust the temperature of the blown air (air conditioning wind) mixed in the mixing space.

In addition, an opening hole not shown is provided on the most downstream portion of the casing 41 in the blown air flow. The air conditioning wind mixed in the mixing space is blown through the opening hole into the vehicle compartment as an air-conditioning target space. Specifically, a face opening hole, a foot opening hole, and defroster opening hole are provided as the opening holes. The face opening hole is provided for blowing the air conditioning wind toward an upper body of an occupant present in the vehicle compartment, the foot opening hole is provided for blowing the air conditioning wind toward feet of the occupant, and the defroster opening hole is provided for blowing the air conditioning wind toward an inner surface of a windshield of a vehicle.

The blown air flow downstream sides of the face opening hole, the foot opening hole, and the defroster opening hole are connected to a face blowing port, a foot blowing port, and a defroster blowing port (all of them are not shown), which are provided in the vehicle compartment, through ducts that form air passages, respectively.

Further, a face door that adjusts the area of the face opening hole, a foot door that adjusts the opening area of the foot opening hole, and a defroster door that adjusts the area of the defroster opening hole (all of them are not shown) are disposed on the blown air flow upstream sides of the face opening hole, the foot opening hole, and the defroster opening hole, respectively.

The face doors, the foot doors, and the defroster doors each configure an opening hole mode switching device for switching an opening hole mode, are coupled with electric actuators for driving the blowing port mode doors through link mechanisms, and rotationally operated in association with the electric actuators. Meanwhile, the operation of this electric actuator is also controlled by a control signal that is output from the control device.

The control device not shown includes a well-known microcomputer including a CPU, a ROM and a RAM, and peripheral circuits of the microcomputer. The control device controls the operation of the above-mentioned various electric actuators by performing various calculations and processing on the basis of a control program stored in the ROM.

Further, the control device is connected with an air conditioning control sensor set such as an inside air temperature sensor, an outside air temperature sensor, an insolation sensor, an evaporator temperature sensor, a coolant temperature sensor, a discharge pressure sensor. The control device receives detection values from the group of those sensors. The inside air temperature sensor detects a vehicle interior temperature (interior temperature) Tr. The outside air temperature sensor detects an outside air temperature Tam. The insolation sensor detects the amount of insolation As in the vehicle compartment. The evaporator temperature sensor detects the blowing air temperature from the evaporator 14 (the temperature of the evaporator) Tefin. The coolant temperature sensor detects a coolant temperature Tw of an engine coolant flowing into the heater core 44. The discharge pressure sensor detects a pressure Pd of the high-pressure refrigerant discharged from the compressor 11.

Furthermore, an operation panel not shown, which is disposed in the vicinity of an instrument panel positioned at a front part in the vehicle compartment, is connected to the input side of the control device, and operation signals output from various operation switches mounted on the operation panel are input to the control device. An air conditioning operation switch that is used to perform air conditioning in the vehicle compartment, a vehicle interior temperature setting switch that is used to set a vehicle interior setting temperature Tset, and the like are provided as the various operation switches that are mounted on the operation panel.

Meanwhile, the control device of the present embodiment is integrated with a control unit for controlling the operations of various control target devices connected to the output side of the control device, but a configuration of the control device (hardware and software), which controls the operations of the respective control target devices forms the control unit of the respective control target devices. For example, in the present embodiment, a configuration which controls the operation of the discharge capacity control valve of the compressor 11 configures a discharge capacity control unit.

Subsequently, the operation of the present embodiment having the above configuration will be described. In the vehicle air conditioning apparatus according to the present embodiment, when an air conditioning operation switch of the operation panel is turned on (ON), the control device executes an air conditioning control program stored in a storage circuit in advance.

The air conditioning control program reads the detection signals from the above air conditioning control sensor set, and the operation signals of the operation panel. Subsequently, the control device calculates a target blowing temperature TAO that is a target temperature of the air that is blown into the vehicle compartment on the basis of the read detection signals and the read operation signals.

The target blowing temperature TAO is calculated by Formula F1 below.

TAO=Kser*Tset−Kr*Tr−Kam*Tam−Ks*As+C (F1)

Meanwhile, Tset denotes a vehicle interior setting temperature that is set by the temperature setting switch, Tr denotes an interior temperature that is detected by the inside air temperature sensor, Tam denotes the outside air temperature that is detected by the outside air temperature sensor, and As denotes an amount of insolation that is detected by the insolation sensor. Kset, Kr, Kam, Ks denote control gains, and C denotes a constant for correction.

Further, the air conditioning control program determines operation states of the various control target devices connected to the output side of the control device on the basis of the calculated target blowing temperature TAO and the detection signals of the sensor group.

For example, the refrigerant discharge capacity of the compressor 11, that is, a control current to be output to the discharge capacity control valve of the compressor 11 is determined as described below. First, a target evaporator blowing temperature TEO of the blown air blown from the evaporator 14 is determined on the basis of the target blowing temperature TAO with reference to a control map that is stored in a storage circuit in advance.

Then, the control current to be output to the discharge capacity control valve of the compressor 11 is determined through a feedback control technique on the basis of a deviation between the evaporator temperature Tefin detected by the evaporator temperature sensor and the target evaporator blowing temperature TEO so that the evaporator temperature Tefin comes closer to the target evaporator blowing temperature TEO.

The rotation speed of the blower 42, that is, a control voltage to be output to the blower 42 is determined on the basis of the target blowing temperature TAO with reference to the control map stored in the storage circuit in advance. More specifically, the blown air amount is controlled to come close to a maximum amount with the control voltage to be output to the electric motor as a maximum in a cryogenic range of the target blowing temperature TAO (maximum cooling range) and an extremely high temperature range (maximum heating range), and the blown air amount is reduced more as the target blowing temperature TAO comes closer to an intermediate temperature range.

Also, an opening degree of the air mixture door 46, that is, a control signal to be output to the electric actuator for driving the air mixture door is determined so that the temperature of the blown air blown into the vehicle compartment comes closer to the target blowing temperature TAO on the basis of the evaporator temperature Tefin and the coolant temperature Tw.

Then, the control device outputs the control signal and so on determined as described above to the various control target devices. Thereafter, a control routine of reading the detection signals and the operation signals described above, calculating the target blowing temperature TAO, determining the operation states of the various control target devices, and outputting the control signal, and so on is repeated in the stated order for each predetermined control cycle until the actuation stop of the vehicle air conditioning apparatus is requested.

With the above operation, in the ejector-type refrigeration cycle 10, the refrigerant flows as indicated by thick solid arrows in FIG. 1.

In other words, a high-temperature high-pressure refrigerant discharged from the compressor 11 flows into the condensing portion 12a of the radiator 12. The refrigerant that has flowed into the condensing portion 12a performs the heat exchange with the outside air blown from the cooling fan 12d, radiates the heat, and is condensed. The refrigerant condensed by the condensing portion 12a is separated into gas and liquid by the receiver portion 12b. A liquid-phase refrigerant, which has been subjected to gas-liquid separation in the receiver portion 12b, performs heat exchange with the outside air blown from the cooling fan 12d by the subcooling portion 12c, and radiates heat into a subcooled liquid-phase refrigerant.

The subcooled liquid-phase refrigerant that has flowed out of the subcooling portion 12c of the radiator 12 is isentropically depressurized by the nozzle passage 13a, and ejected. The nozzle passage 13a is defined between an inner peripheral surface of the depressurizing space 30b of the ejector module 13 and an outer peripheral surface of the passage formation member 35. In this situation, a refrigerant passage area of the depressurizing space 30b in the minimum passage area portion 30m is regulated so that the degree of superheating of the refrigerant on the outlet side of the evaporator 14 comes closer to a reference degree of superheat.

The refrigerant that has flowed out of the evaporator 14 is drawn into the ejector module 13 from the refrigerant suction port 31b due to the suction action of the ejection refrigerant which has been ejected from the nozzle passage 13a. The ejection refrigerant ejected from the nozzle passage 13a and the drawn refrigerant drawn through the suction passage 13b flow into the diffuser passage 13c and join together.

In the diffuser passage 13c, a kinetic energy of the refrigerant is converted into a pressure energy due to an increase in a refrigerant passage area. As a result, a pressure of the mixed refrigerant is increased while the ejection refrigerant and the drawn refrigerant are mixed together. The refrigerant that has flowed out of the diffuser passage 13c is separated into gas and liquid in the gas-liquid separation space 30f. The liquid-phase refrigerant separated in the gas-liquid separation space 30f is reduced in pressure in the orifice 31i, and flows into the evaporator 14.

The refrigerant that has flowed into the evaporator 14 absorbs heat from the blown air blown by the blower 42, and evaporates. Accordingly, the blown air is cooled. On the other hand, the gas-phase refrigerant that has been separated in the gas-liquid separation space 30f flows out of the gas-phase refrigerant outflow port 31d, is drawn into the compressor 11, and again compressed.

The blown air cooled by the evaporator 14 flows into an air flow passage on the heater core 44 side and the cold air bypass passage 45 according to the opening degree of the air mixture door 46. The cold air that has flowed into the air flow passage on the heater core 44 side is again heated when passing through the heater core 44, and is mixed with the cold air that has passed through the cold air bypass passage 45 in the mixing space. Subsequently, the air conditioning wind adjusted in temperature in the mixing space is blown from the mixing space into the vehicle compartment via the respective blowing ports.

As described above, according to the vehicle air conditioning apparatus of the present embodiment, the air conditioning in the vehicle compartment can be performed. In addition, according to the ejector-type refrigeration cycle 10 of the present embodiment, since the refrigerant that has been increased in pressure by the diffuser passage 13c is drawn into the compressor 11, the driving power of the compressor 11 is reduced more, thereby being capable of improving the cycle efficiency (COP) than that in the normal refrigeration cycle device.

Incidentally, the normal refrigeration cycle device is configured by connecting the compressor, the radiator, the depressurizing device (expansion valve), and the evaporator in a ring shape. Therefore, in the normal refrigeration cycle device, the pressure of the drawn refrigerant to be drawn into the compressor is substantially equal to the refrigerant evaporation pressure in the evaporator.

In the ejector-type refrigeration cycle 10 according to the present embodiment, a density of the drawn refrigerant to be drawn into the compressor 11 is increased, and a flow rate (mass flow rate) of the drawn refrigerant is likely to increase as compared with the normal refrigeration cycle device. For that reason, in the ejector-type refrigeration cycle 10 according to the present embodiment, a pressure loss occurring when the drawn refrigerant flows in a suction pipe 15c is likely to increase.

Further, the pressure loss is increased with an increase in a length of the suction pipe 15c. Therefore, in the ejector-type refrigeration cycle 10 according to the present embodiment, the degree of a reduction of the COP to the length of the suction pipe may be increased more than that in the normal refrigeration cycle device.

On the contrary, according to the ejector-type refrigeration cycle 10 of the present embodiment, the length of the suction pipe 15c is shorter than the length of the outlet pipe 15e, the pressure loss that occurs in the refrigerant flowing in the suction pipe 15c is set to be smaller than the pressure loss that occurs in the refrigerant flowing in the outlet pipe 15e. Therefore, the COP improvement effect of the ejector-type refrigeration cycle 10 can be surely obtained.

In more detail, the refrigerant that is drawn from the refrigerant outflow port of the evaporator 14 into the refrigerant suction port 31b through the outlet pipe 15e flows into the outlet pipe 15e due to the refrigerant suction action of the ejector module 13. For that reason, the flow rate (mass flow rate) of the refrigerant that flows in the outlet pipe 15e is smaller than the flow rate (mass flow rate) of the refrigerant that flows in the suction pipe 15c due to the suction and discharge action of the compressor 11.

For that reason, the pressure loss that occurs in the refrigerant flowing in the suction pipe 15c is set to be smaller than the pressure loss that occurs in the refrigerant flowing in the outlet pipe 15e, thereby being capable of sufficiently reducing the pressure loss that occurs in the refrigerant flowing in the suction pipe 15c.

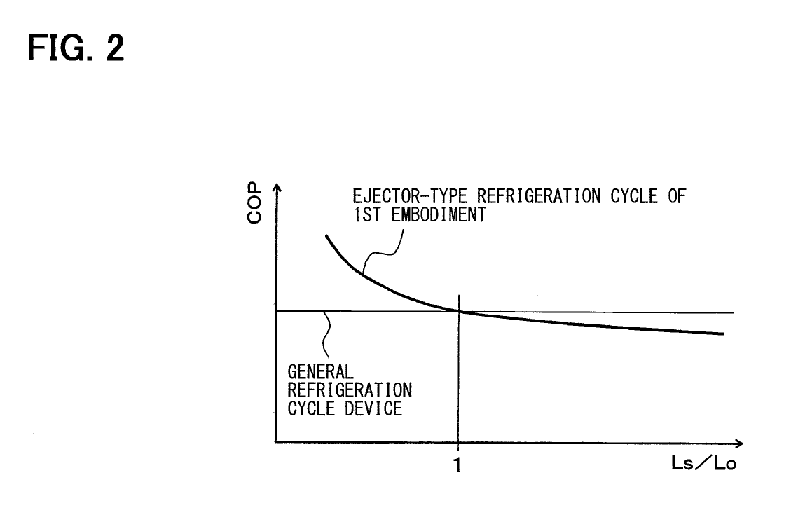

In more detail, according to the present inventors'study, when a length of the suction pipe 15c is defined as Ls, a length of the outlet pipe 15e is defined as Lo, and a pipe length ratio is defined as Ls/Lo, it is confirmed that a relationship between the pipe length ratio Ls/Lo and the COP under a predetermined general operating condition is changed as indicated by a graph of FIG. 2.

In other words, it is confirmed that, in a range (that is, a range of Ls<10 m) of the length of the suction pipe for the normal refrigeration cycle device used in the general vehicle air conditioning apparatus, the COP can be improved more than that of the normal refrigeration cycle device when Ls/Lo<1 is satisfied.

Therefore, in the ejector-type refrigeration cycle 10, the COP can be improved more than that in the normal refrigeration cycle device when the length Ls of the suction pipe 15c is shorter than the length Lo of the outlet pipe 15e in a range where the length Ls of the suction pipe 15c is equal to or shorter than 10 m. As a result, according to the ejector-type refrigeration cycle 10 of the present embodiment, the COP improvement effect can sufficiently be obtained.

### Second Embodiment

As in the ejector-type refrigeration cycle 10 described in the first embodiment, in a configuration where the ejector module 13 is connected to the evaporator 14, a length of an outlet pipe 15e is substantially equal to a length of an inlet pipe 15d. For that reason, as in the ejector-type refrigeration cycle 10 according to the first embodiment, when the length of the outlet pipe 15e is set to be longer than the length of the suction pipe 15c, the length of the inlet pipe 15d is likely to become longer.

However, when the length of the inlet pipe 15d becomes longer, the refrigerant (liquid-phase refrigerant) that flows in the inlet pipe 15d is likely to absorb the heat in the engine room, and the enthalpy of the refrigerant flowing into the evaporator 14 is likely to increase. For that reason, when the length of the inlet pipe 15d becomes longer, there is a risk that the refrigeration capacity exerted on the evaporator 14 may be reduced.

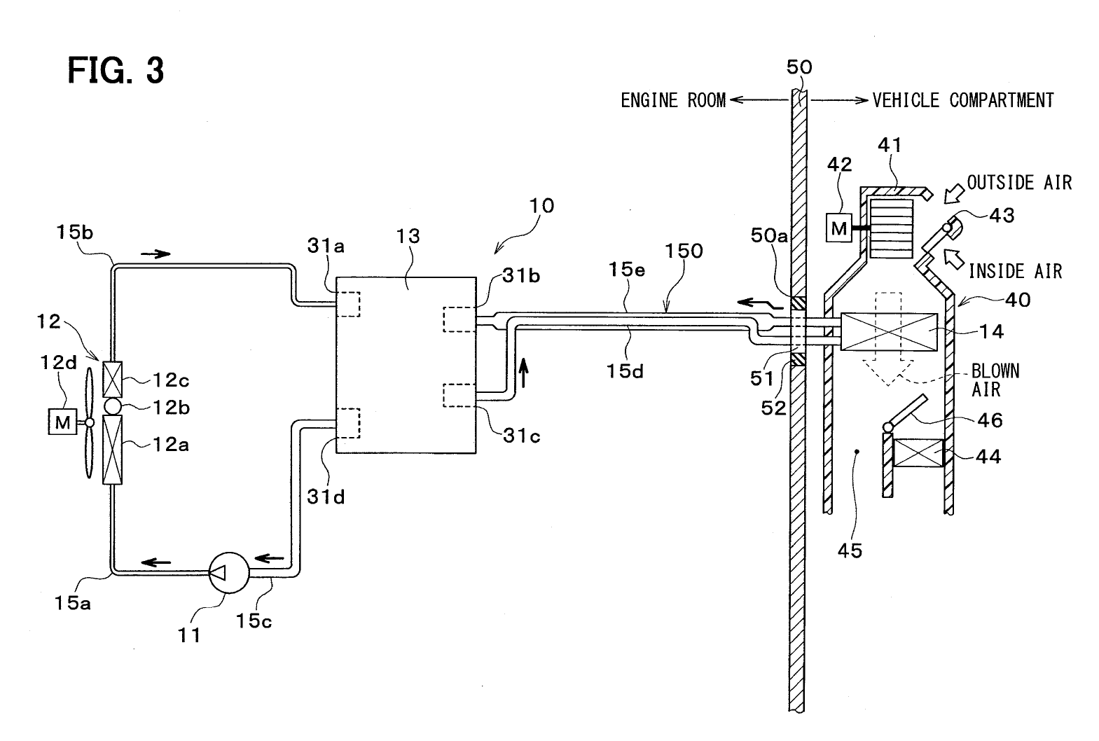

On the contrary, in the present embodiment, as illustrated in a schematic overall configuration diagram of FIG. 3, at least one of the outlet pipe 15e and the inlet pipe 15d is configured by a double pipe 150. In more detail, at least a part of the outlet pipe 15e is configured by an outer pipe of the double pipe 150, and at least a part of the inlet pipe 15d is configured by an inner pipe of the double pipe 150.

In this example, the “double pipe” represents a pipe that includes two pipes different in diameter from each other in which an inner pipe smaller in diameter is disposed inside an outer pipe larger in diameter. In FIG. 3, similar portions with or equivalent portions to those in the first embodiment are denoted by the same reference numerals. For clarification of the illustration, FIG. 3 illustrates the ejector module 13 simpler than FIG. 1. The other configurations and operation of the ejector-type refrigeration cycle 10 are identical with those in the first embodiment.

Therefore, when the vehicle air conditioning apparatus according to the present embodiment is actuated, the air conditioning in the vehicle interior can be realized as in the first embodiment. In addition, in the ejector-type refrigeration cycle 10, the refrigerant flows as indicated by thick solid arrows in FIG. 3, and the same advantages as those in the first embodiment can be obtained.

Further, according to the ejector-type refrigeration cycle 10 of the present embodiment, at least a part of the outlet pipe 15e is configured by the outer pipe of the double pipe 150, and at least a part of the inlet pipe 15d is configured by the inner pipe of the double pipe 150.

Therefore, the refrigerant to flow into the evaporator 14, which flows on the inner peripheral side of the inner pipe of the double pipe 150, can be restrained from absorbing the heat in the engine room by the aid of the refrigerant to flow into the evaporator 14, which flows on the inner peripheral side of the outer pipe of the double pipe 150 and on the outer peripheral side of the inner pipe. As a result, a reduction in the refrigeration capacity exerted on the evaporator 14 can be suppressed.

### Third Embodiment

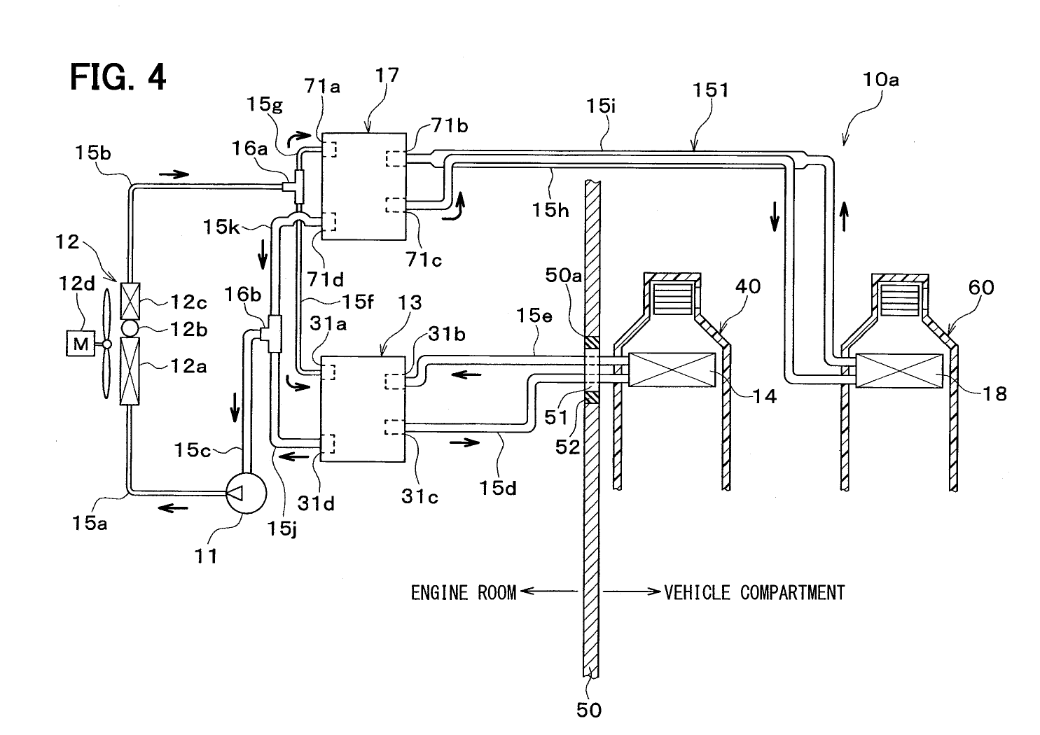

In the present embodiment, an example in which an ejector-type refrigeration cycle 10a illustrated in an overall configuration diagram of FIG. 4 is applied to a so-called dual type vehicle air conditioning apparatus having a front seat side vehicle interior air conditioning unit 40 for adjusting a temperature of a front seat side blown air to be blown mainly to a vehicle front seat side and a rear seat side vehicle interior air conditioning unit 60 for adjusting a temperature of a rear seat side blown air to be blown mainly to a vehicle rear seat side will be described.

In more detail, the ejector-type refrigeration cycle 10a according to the present embodiment includes a branch portion 16a for branching a flow of the refrigerant that has flowed out of a radiator 12. In other words, a refrigerant outflow port of a subcooling portion 12c in the radiator 12 is connected with a refrigerant inflow port of the branch portion 16a through a downstream side high-pressure pipe 15b. The branch portion 16a is configured by a three-way joint, and one of three refrigerant inflow and outflow ports is used as a refrigerant inflow port, and the remaining two refrigerant inlet/outlet ports are used as refrigerant outflow ports.

One refrigerant outflow port of the branch portion 16a is connected with a refrigerant inflow port 31a of the ejector module 13 through a front seat side high-pressure pipe 15f. A liquid-phase refrigerant outflow port (first liquid-phase refrigerant outflow port) 31c and a refrigerant suction port 31b (first refrigerant suction port) of the ejector module 13 are connected with an evaporator 14 disposed in a vehicle interior air conditioning unit 40 as in the first embodiment. In the present embodiment, the temperature of the front seat side blown air is mainly adjusted by the vehicle interior air conditioning unit 40.

Under the circumstance, in the following description, for clarification of the description, the ejector module 13 is called “front seat side ejector module 13”, the evaporator 14 is called “front seat side evaporator (first evaporator) 14, the inlet pipe 15d is called “front seat side inlet pipe (first inlet pipe) 15d, the outlet pipe 15e is called “front seat side outlet pipe (first outlet pipe) 15e, and the vehicle interior air conditioning unit 40 is called “front seat side vehicle interior air conditioning unit 40”.

In other words, the front seat side ejector module 13 is a first ejector module that includes a first body portion having a first nozzle portion, a first refrigerant suction port, a first pressure increase portion, and a first gas-liquid separation portion. The first nozzle portion reduces a pressure of one refrigerant branched by the branch portion 16a. The first refrigerant suction port draws the refrigerant due to the suction action of a first ejection refrigerant which is ejected at high speed from the first nozzle portion. The first pressure increase portion mixes the first ejection refrigerant with a first drawn refrigerant drawn from the first refrigerant suction port, and increases a pressure of the mixed refrigerant. The first gas-liquid separation portion separates the refrigerant that has flowed out of the first pressure increase portion into gas and liquid.

The other refrigerant outflow port of the branch portion 16a is connected with a rear seat side refrigerant inflow port 71a of a rear seat side ejector module 17 through a rear seat side high-pressure pipe 15g. A basic configuration of the rear seat side ejector module 17 is identical with the front seat side ejector module 13.

Therefore, similarly, a body portion of the rear seat side ejector module 17 is provided with the rear seat side refrigerant inflow port 71a, a rear seat side refrigerant suction port (second refrigerant suction port) 71b, a rear seat side liquid-phase refrigerant outflow port (second liquid-phase refrigerant outflow port) 71c, and a rear seat side gas-phase refrigerant outflow port (second gas-phase refrigerant outflow port) 71d as in the front seat side ejector module 13.

In other words, the rear seat side ejector module 17 is a second ejector module that includes a second body portion having a second nozzle portion, a second refrigerant suction port, a second pressure increase portion, and a second gas-liquid separation portion. The second nozzle portion reduces a pressure of the other refrigerant branched by the branch portion 16a. The second refrigerant suction port draws the refrigerant due to the suction action of a second ejection refrigerant which is ejected at high speed from the second nozzle portion. The second pressure increase portion mixes the second ejection refrigerant with a second drawn refrigerant drawn from the second refrigerant suction port, and increases a pressure of the mixed refrigerant. The second gas-liquid separation portion separates the refrigerant that has flowed out of the second pressure increase portion into gas and liquid.

Further, the rear seat side ejector module 17 is disposed in the engine room together with the front seat side ejector module 13.

The rear seat side liquid-phase refrigerant outflow port 71c of the rear seat side ejector module 17 is connected with a refrigerant inflow port of a rear seat side evaporator (second evaporator) 18 through a rear seat side inlet pipe (second inlet pipe) 15h. A refrigerant outflow port of the rear seat side evaporator 18 is connected with the rear seat side refrigerant suction port 71b of the rear seat side ejector module 17 through a rear seat side outlet pipe (second outlet pipe) 15i.

Further, as illustrated in FIG. 4, at least one of the rear seat side outlet pipe 15i and the rear seat side inlet pipe 15h in the present embodiment is configured by a double pipe 151. In more detail, at least a part of the rear seat side outlet pipe 15i according to the present embodiment is configured by an outer pipe of the double pipe 151, and at least a part of the rear seat side inlet pipe 15h is configured by an inner pipe of the double pipe 151.

The rear seat side evaporator 18 is housed in the rear seat side vehicle interior air conditioning unit 60. A basic configuration of the rear seat side vehicle interior air conditioning unit 60 is identical with that of the front seat side vehicle interior air conditioning unit 40. The rear seat side vehicle interior air conditioning unit 60 is disposed at a rear side of the vehicle compartment, and mainly adjusts a temperature of the rear seat side blown air.

In this example, the rear seat side ejector module 17 is disposed in the engine room in front of the vehicle compartment, and the vehicle interior air conditioning unit 60 (rear seat side evaporator 18) is disposed at the rear of the vehicle compartment. For that reason, the lengths of the rear seat side inlet pipe 15h and the rear seat side outlet pipe 15i are set to be longer than those of the front seat side inlet pipe 15d and the front seat side outlet pipe 15e.

Under the circumstance, in the present embodiment, the double pipe 151 configuring the rear seat side outlet pipe 15i and the rear seat side inlet pipe 15h is disposed on a lower side (under floor) of the vehicle compartment.

Also, the front seat side gas-phase refrigerant outflow port (first gas-phase refrigerant outflow port) 31d of the front seat side ejector module 13 is connected with one refrigerant inflow port of a merging portion 16b through a front seat side suction pipe 15j. Further, the rear seat side gas-phase refrigerant outflow port 71d of the rear seat side ejector module 17 is connected to the other refrigerant inflow port of the merging portion 16b through a rear seat side suction pipe 15k.

The merging portion 16b merges a flow of the refrigerant that has flowed out of the front seat side gas-phase refrigerant outflow port 31d of the front seat side ejector module 13 and a flow of the refrigerant that has flowed out of the rear seat side gas-phase refrigerant outflow port 71d of the rear seat side ejector module 17 together, and a basic configuration of the merging portion 16b is identical with the branch portion 16a. In other words, in the merging portion 16b, two of three refrigerant inflow and outflow ports are used as the refrigerant inflow ports, and the remaining one port is used as the refrigerant outflow port.

The refrigerant outflow port of the merging portion 16b is connected with the suction port of the compressor 11 through the suction pipe 15c. Therefore, the front seat side evaporator 14 and the rear seat side evaporator 18 according to the present embodiment are connected in parallel to the compressor 11 as illustrated in FIG. 4.

Further, in the present embodiment, a length of the first suction pipe (that is, a total length of the front seat side suction pipe 15j and the suction pipe 15c) extending from the front seat side gas-phase refrigerant outflow port 31d to the suction port of the compressor 11 through the merging portion 16b is set to be shorter than the front seat side outlet pipe 15e. A pressure loss that occurs when the refrigerant flows in the first suction pipe is lower than a pressure loss that occurs when the refrigerant flows in the front seat side outlet pipe 15e. Further, in the present embodiment, a length of the first suction pipe according to the present embodiment is set to be equal to or shorter than 10 m.

Further, in the present embodiment, a length of the second suction pipe (that is, a total length of the rear seat side suction pipe 15k and the suction pipe 15c) extending from the rear seat side gas-phase refrigerant outflow port 71d to the suction port of the compressor 11 through the merging portion 16b is set to be shorter than the rear seat side outlet pipe 15i. A pressure loss that occurs when the refrigerant flows in the second suction pipe is set to be lower than a pressure loss that occurs when the refrigerant flows in the rear seat side outlet pipe 15i.

In this example, in the first suction pipe and the second suction pipe, the suction pipe 15c serves as the common refrigerant flow channel. Under the circumstances, the pressure loss occurring when closing the inflow port of the rear seat side suction pipe 15k side of the merging portion 16b may be employed as the pressure loss occurring when flowing in the first suction pipe. In addition, the pressure loss occurring when closing the inflow port of the front seat side suction pipe 15j side of the merging portion 16b may be employed as the pressure loss occurring when flowing in the second suction pipe.

Incidentally, for clarification of the illustration, FIG. 4 illustrates the front seat side ejector module 13 and the rear seat side ejector module 17 as well as the front seat side vehicle interior air conditioning unit 40 and the rear seat side vehicle interior air conditioning unit 60 simpler than an equivalent configuration of FIG. 1.

Therefore, when the vehicle air conditioning apparatus according to the present embodiment is actuated, the refrigerant flows in the ejector-type refrigeration cycle 10a as indicated by thick solid arrows in FIG. 4. With the above configuration, the front seat side blown air can be cooled by the front seat side evaporator 14 connected in parallel as in the first embodiment, and the rear seat side blown air can be cooled by the rear seat side evaporator 18.

The air conditioning wind, which has been subjected to temperature adjustment, is blown from the front seat side vehicle interior air conditioning unit 40 to the vehicle front seat side, and the conditioned air, which has been subjected to temperature adjustment, is blown from the rear seat side vehicle interior air conditioning unit 60 to the vehicle rear seat side. Thus, the air conditioning in the vehicle compartment can be performed.

Also, according to the ejector-type refrigeration cycle 10a of the present embodiment, the length of the first suction pipe is set to be shorter than the front seat side outlet pipe 15e. A pressure loss that occurs when the refrigerant flows in the first suction pipe is set to be lower than a pressure loss that occurs when the refrigerant flows in the front seat side outlet pipe 15e.

Further, the length of the second suction pipe is set to be shorter than the length of the rear seat side outlet pipe 15i, the pressure loss that occurs in the refrigerant flowing in the second suction pipe is set to be smaller than the pressure loss that occurs in the refrigerant flowing in the rear seat side outlet pipe 15i. Therefore, as in the first embodiment, the refrigerant pressure immediately before the refrigerant is drawn into the compressor 11 can be restrained from being largely decreased. As a result, the COP improvement effect of the ejector-type refrigeration cycle 10a can be sufficiently obtained.

Further, in the ejector-type refrigeration cycle 10a according to the present embodiment, at least a part of the rear seat side outlet pipe 15i is configured by the outer pipe of the double pipe 151, and at least a part of the rear seat side inlet pipe 15h is configured by the inner pipe of the double pipe 151.

Therefore, the refrigerant to flow into the rear seat side evaporator 18, which flows on the inner peripheral side of the inner pipe of the double pipe 151, can be restrained from absorbing the heat in the engine room by the aid of the refrigerant to flow out of the rear seat side evaporator 18, which flows on the inner peripheral side of the outer pipe of the double pipe 151 and on the outer peripheral side of the inner pipe. As a result, a reduction in the refrigeration capacity exerted on the rear seat side evaporator 18 can be suppressed.

Further, in the present embodiment, the length of the rear seat side inlet pipe 15h is longer than the length of the front seat side inlet pipe 15d. For that reason, the refrigerant that flows in the rear seat side inlet pipe 15h is likely to absorb the heat from the external as compared with the refrigerant that flows in the front seat side inlet pipe 15d. Therefore, that at least a part of the rear seat side inlet pipe 15h is configured by the inner pipe of the double pipe 151 is effective in that a reduction in the refrigeration capacity in the rear seat side evaporator 18 where the refrigerant capacity is likely to be reduced can be suppressed.

Incidentally, as a modification of the present embodiment, an opening and closing device for opening and closing the rear seat side high-pressure pipe 15g may be added. When the temperature adjustment for the rear seat side blown air is not performed, the rear seat side high-pressure pipe 15g may be closed by the opening and closing device. According to the above configuration, when the temperature adjustment for the rear seat side blown air is not performed, the entirely same cycle configuration as that in the first embodiment can be realized, and the same advantages as those in the first embodiment can be obtained.

The present disclosure is not limited to the above-described embodiments, but various modifications can be made thereto as follows without departing from the spirit of the present disclosure.

In the above first and second embodiments, the examples in which the length of the suction pipe 15c is set to be shorter than the length of the outlet pipe 15e have been described. However, if the pressure loss occurring in the suction pipe 15c is set to be smaller than the pressure loss occurring in the outlet pipe 15e, the length of the suction pipe 15c may be set to be longer than the length of the outlet pipe 15e.

For example, when the suction pipe 15c is linearly shaped, and the outlet pipe 15e is shaped in a meander shape, even if the length of the suction pipe 15c is longer than the length of the outlet pipe 15e, the pressure loss occurring in the suction pipe 15c can be set to be smaller than the pressure loss occurring in the outlet pipe 15e.

The same is applied to the first suction pipe (that is, the front seat side suction pipe 15j and the suction pipe 15c) and the front seat side outlet pipe 15e as well as the second suction pipe (that is, the rear seat side suction pipe 15k, and the suction pipe 15c) and the rear seat side outlet pipe 15i in the third embodiment.

In the third embodiment described above, the example in which the front seat side ejector module 13 is employed as the front seat side pressure reducing device for reducing the pressure of the refrigerant to flow into the evaporator 14, and the rear seat side ejector module 17 is employed as the rear seat side pressure reducing device for reducing the pressure of the refrigerant to flow into the rear seat side evaporator 18 has been described. Alternatively, any one of the front seat side pressure reducing device and the rear seat side pressure reducing device may be configured by a depressurizing device (for example, temperature type expansion valve) other than the ejector.

In addition, in the above third embodiment, the example in which the rear seat side outlet pipe 15i and the rear seat side inlet pipe 15h are configured by the double pipe 151 has been described. Alternatively, the front seat side outlet pipe 15e and the front seat side inlet pipe 15d may be configured by the double pipe. Further, both of the rear seat side outlet pipe 15i and the rear seat side inlet pipe 15h as well as both of the front seat side outlet pipe 15e and the front seat side inlet pipe 15d may be configured by the double pipe.

Moreover, the inside of the rear seat side outlet pipe 15i configured by the outer pipe of the double pipe is equipped with the front seat side inlet pipe 15d configured by the inner pipe, or may be equipped with both of the front seat side inlet pipe 15d and the rear seat side inlet pipe 15h. Likewise, the inside of the front seat side outlet pipe 15e configured by the outer pipe may be equipped with the rear seat side inlet pipe 15h configured by the inner pipe, or may be equipped with both of the front seat side inlet pipe 15d and the rear seat side inlet pipe 15h.

In the third embodiment described above, the pipe diameters (passage cross-sectional areas) of the rear seat side outlet pipe 15i and the rear seat side inlet pipe 15h as well as the front seat side outlet pipe 15e and the front seat side inlet pipe 15d have not been described. It is desirable that the pipe diameter of at least the rear seat side outlet pipe 15i is set to be smaller than the pipe diameter of the front seat side outlet pipe 15e.

The reason is because the pipe diameter of the rear seat side outlet pipe 15i is set to be smaller with the result that a flow velocity of the refrigerant flowing in the rear seat side outlet pipe 15i can be increased. With the above configuration, since the refrigerator oil is likely to be returned from the rear seat side evaporator 18 to the rear seat side ejector module 17, the refrigerator oil can be restrained from staying in the rear seat side evaporator 18.

The respective components configuring the ejector-type refrigeration cycles 10 and 10a are not limited to the components disclosed in the above embodiments.

For example, in the above embodiments, the example in which the variable capacity type compressor is employed as the compressor 11 has been described. However, the compressor 11 is not limited to the above configuration. For example, as the compressor 11, a fixed capacity type compressor which is driven by a rotational drive force output from the engine through an electromagnetic clutch, a belt, and so on may be employed. In a fixed capacity type compressor, an operation rate of the compressor may be changed by intermittent operation of the electromagnetic clutch to adjust the refrigerant discharge capacity. Furthermore, as the compressor 11, an electric compressor that adjusts the refrigerant discharge capacity while changing the rotational speed of an electric motor may be employed.

In addition, in the above-described embodiments, examples in which a subcooling heat exchanger is employed as the radiator 12 have been described, but, it is needless to say that a normal radiator formed of only the condensing portion 12a may be employed as the radiator 12. Further, with a normal radiator, a liquid receiver (receiver) that separates the refrigerant radiated by the radiator into gas and liquid, and stores an excess liquid-phase refrigerant may be employed.

In the above embodiments, the example in which the ejector-type refrigeration cycle 10 of the present disclosure is applied to the vehicle air conditioning apparatus has been described, but the application of the ejector-type refrigeration cycle 10 of the present disclosure is not limited to the above configuration. For example, the ejector-type refrigeration cycle may be applied to a vehicle refrigeration apparatus, a stationary air conditioning apparatus, a cold storage warehouse or the like.

The present disclosure has been described based on the embodiments; however, it is understood that this disclosure is not limited to the embodiments or the structures. The present disclosure includes various modification examples, or modifications within an equivalent range. In addition, various combinations or forms, and other combinations or forms including only one element, more than or less than one among these combinations or forms are included in the scope or the technical scope of the present disclosure.

What is claimed is:

1. An ejector-type refrigeration cycle comprising:
a compressor that compresses and discharges a refrigerant;
a radiator that radiates heat of the refrigerant discharged from the compressor;
an ejector module including a body portion that includes: a nozzle portion which reduces a pressure of the refrigerant which has flowed out of the radiator; a refrigerant suction port which draws a refrigerant by a suction action of an ejection refrigerant ejected at high speed from the nozzle portion; a pressure increase portion which mixes the ejection refrigerant with a drawn refrigerant drawn from the refrigerant suction port and increases a pressure of the mixed refrigerant; a gas-liquid separation portion which separates the refrigerant that has flowed out of the pressure increase portion into gas and liquid; and a gas-phase refrigerant outflow port through which a gas-phase refrigerant separated by the gas-liquid separation portion flows out;
an evaporator that evaporates a liquid-phase refrigerant separated by the gas-liquid separation portion;
a suction pipe that connects the gas-phase refrigerant outflow port to a suction port of the compressor; and
an outlet pipe that connects a refrigerant outflow port of the evaporator to the refrigerant suction port, wherein
the suction pipe and the outlet pipe have a configuration where a pressure loss that occurs in the refrigerant flowing through the suction pipe is smaller than a pressure loss that occurs in the refrigerant flowing through the outlet pipe.

2. An ejector-type refrigeration cycle comprising:
a compressor that compresses and discharges a refrigerant;
a radiator that radiates heat of the refrigerant discharged from the compressor;
an ejector module including a body portion that includes: a nozzle portion which reduces a pressure of the refrigerant which has flowed out of the radiator; a refrigerant suction port which draws a refrigerant by a suction action of an ejection refrigerant ejected at high speed from the nozzle portion; a pressure increase portion which mixes the ejection refrigerant with a drawn refrigerant drawn from the refrigerant suction port and increases a pressure of the mixed refrigerant; a gas-liquid separation portion which separates the refrigerant that has flowed out of the pressure increase portion into gas and liquid; and a gas-phase refrigerant outflow port through which a gas-phase refrigerant separated by the gas-liquid separation portion flows out;
an evaporator that evaporates a liquid-phase refrigerant separated by the gas-liquid separation portion;
a suction pipe that connects the gas-phase refrigerant outflow port to a suction port of the compressor; and
an outlet pipe that connects a refrigerant outflow port of the evaporator to the refrigerant suction port, wherein
a length of the suction pipe is shorter than a length of the outlet pipe.

3. The ejector-type refrigeration cycle according to claim 1, wherein
the body portion further includes a liquid-phase refrigerant outflow port through which the liquid-phase refrigerant separated by the gas-liquid separation portion flows out,
the ejector-type refrigeration cycle further comprising an inlet pipe that connects the liquid-phase refrigerant outflow port to a refrigerant inflow port of the evaporator, wherein
the outlet pipe includes an outer pipe of a double pipe, and
the inlet pipe includes an inner pipe of the double pipe.

4. The ejector-type refrigeration cycle according to claim 1, wherein
the ejector-type refrigeration cycle is applied to a vehicle air conditioning apparatus, and
a length of the suction pipe is equal to or shorter than 10 meters.

5. An ejector-type refrigeration cycle comprising:
a compressor that compresses and discharges a refrigerant;
a radiator that radiates heat of the refrigerant discharged from the compressor;
a branch portion that branches a flow of the refrigerant that has flowed out of the radiator;
a first ejector module including a first body portion that includes: a first nozzle portion that reduces a pressure of one refrigerant branched by the branch portion; a first refrigerant suction port that draws a refrigerant by a suction action of a first ejection refrigerant ejected at high speed from the first nozzle portion; a first pressure increase portion that mixes the first ejection refrigerant with a first drawn refrigerant drawn from the first refrigerant suction port and increases a pressure of the mixed refrigerant; a first gas-liquid separation portion that separates the refrigerant that has flowed out of the first pressure increase portion into gas and liquid; a first gas-phase refrigerant outflow port through which a gas-phase refrigerant separated by the first gas-liquid separation portion flows out; and a first liquid-phase refrigerant outflow port through which a liquid-phase refrigerant separated by the first gas-liquid separation portion flows out;
a first evaporator that evaporates the liquid-phase refrigerant separated by the first gas-liquid separation portion;
a second ejector module including a second body portion that includes: a second nozzle portion that reduces a pressure of another refrigerant branched by the branch portion; a second refrigerant suction port that draws a refrigerant by a suction action of a second ejection refrigerant ejected at high speed from the second nozzle portion; a second pressure increase portion that mixes the second ejection refrigerant with a second drawn refrigerant drawn from the second refrigerant suction port and increases a pressure of the mixed refrigerant; a second gas-liquid separation portion that separates the refrigerant that has flowed out of the second pressure increase portion into gas and liquid; and a second gas-phase refrigerant outflow port through which a gas-phase refrigerant separated by the second gas-liquid separation portion flows out; and a second liquid-phase refrigerant outflow port through which a liquid-phase refrigerant separated by the second gas-liquid separation portion flows out;
a second evaporator that evaporates the liquid-phase refrigerant separated by the second gas-liquid separation portion;
a first suction pipe that connects the first gas-phase refrigerant outflow port to a suction port of the compressor;
a first outlet pipe that connects a refrigerant outflow port of the first evaporator to the first refrigerant suction port;
a second suction pipe that connects the second gas-phase refrigerant outflow port to the suction port of the compressor;
a second outlet pipe that connects a refrigerant outflow port of the second evaporator to the second refrigerant suction port;
a first inlet pipe that connects the first liquid-phase refrigerant outflow port to a refrigerant inflow port of the first evaporator; and
a second inlet pipe that connects the second liquid-phase refrigerant outflow port to a refrigerant inflow port of the second evaporator, wherein
the first suction pipe and the first outlet pipe have a configuration where a pressure loss that occurs in the refrigerant flowing through the first suction pipe to be smaller than a pressure loss that occurs in the refrigerant flowing through the first outlet pipe,
the second suction pipe and the second outlet pipe have a configuration where a pressure loss that occurs in the refrigerant flowing through the second suction pipe to be smaller than a pressure loss that occurs in the refrigerant flowing through the second outlet pipe,
at least one of the first outlet pipe and the second outlet pipe includes an outer pipe of a double pipe, and
at least one of the first inlet pipe and the second inlet pipe includes an inner pipe of the double pipe.

6. An ejector-type refrigeration cycle comprising:
a compressor that compresses and discharges a refrigerant;
a radiator that radiates heat of the refrigerant discharged from the compressor;
a branch portion that branches a flow of the refrigerant that has flowed out of the radiator;
a first ejector module including a first body portion that includes: a first nozzle portion that reduces a pressure of one refrigerant branched by the branch portion; a first refrigerant suction port that draw a refrigerant by a suction action of a first ejection refrigerant ejected at high speed from the first nozzle portion; a first pressure increase portion that mixes the first ejection refrigerant with a first drawn refrigerant drawn from the first refrigerant suction port and increases a pressure of the mixed refrigerant; a first gas-liquid separation portion that separates the refrigerant that has flowed out of the first pressure increase portion into gas and liquid; a first gas-phase refrigerant outflow port through which a gas-phase refrigerant separated by the first gas-liquid separation portion flows out; and a first liquid-phase refrigerant outflow port through which a liquid-phase refrigerant separated by the first gas-liquid separation portion flows out;
a first evaporator that evaporates the liquid-phase refrigerant separated by the first gas-liquid separation portion;
a second ejector module including a second body portion that includes: a second nozzle portion that reduces a pressure of another refrigerant branched by the branch portion; a second refrigerant suction port that draws the refrigerant by a suction action of a second ejection refrigerant ejected at high speed from the second nozzle portion; a second pressure increase portion that mixes the second ejection refrigerant with a second drawn refrigerant drawn from the second refrigerant suction port and increases a pressure of the mixed refrigerant; a second gas-liquid separation portion that separates the refrigerant that has flowed out of the second pressure increase portion into gas and liquid; and a second gas-phase refrigerant outflow port through which a gas-phase refrigerant separated by the second gas-liquid separation portion flows out; and a second liquid-phase refrigerant outflow port through which a liquid-phase refrigerant separated by the second gas-liquid separation portion flows out;
a second evaporator that evaporates the liquid-phase refrigerant separated by the second gas-liquid separation portion;
a first suction pipe that connects the first gas-phase refrigerant outflow port to a suction port of the compressor;
a first outlet pipe that connects a refrigerant outflow port of the first evaporator to the first refrigerant suction port;
a second suction pipe that connects the second gas-phase refrigerant outflow port to the suction port of the compressor;
a second outlet pipe that connects a refrigerant outflow port of the second evaporator to the second refrigerant suction port;
a first inlet pipe that connects the first liquid-phase refrigerant outflow port to a refrigerant inflow port of the first evaporator; and
a second inlet pipe that connects the second liquid-phase refrigerant outflow port to a refrigerant inflow port of the second evaporator, wherein
a length of the first suction pipe is set to be shorter than a length of the first outlet pipe,
a length of the second suction pipe is set to be shorter than a length of the second outlet pipe,
at least one of the first outlet pipe and the second outlet pipe includes an outer pipe of a double pipe, and
at least one of the first inlet pipe and the second inlet pipe includes an inner pipe of the double pipe.

7. The ejector-type refrigeration cycle according to claim 5, wherein
a longer one of the first inlet pipe and the second inlet pipe includes an inner pipe of the double pipe.

8. The ejector-type refrigeration cycle according to claim 5, wherein
the ejector-type refrigeration cycle is applied to a vehicle air conditioning apparatus,
the first evaporator performs a heat exchange between the liquid-phase refrigerant separated by the first gas-liquid separation portion and a front-seat side blown air to be blown toward a vehicle front seat, and
a length of the first suction pipe is equal to or lower than 10 meters.

9. The ejector-type refrigeration cycle according to claim 2, wherein
the body portion further includes a liquid-phase refrigerant outflow port through which the liquid-phase refrigerant separated by the gas-liquid separation portion flows out,
the ejector-type refrigeration cycle further comprising an inlet pipe that connects the liquid-phase refrigerant outflow port to a refrigerant inflow port of the evaporator, wherein
the outlet pipe includes an outer pipe of a double pipe, and
the inlet pipe includes an inner pipe of the double pipe.

10. The ejector-type refrigeration cycle according to claim 2, wherein
the ejector-type refrigeration cycle is applied to a vehicle air conditioning apparatus, and
a length of the suction pipe is equal to or shorter than 10 meters.

11. The ejector-type refrigeration cycle according to claim 6, wherein
a longer one of the first inlet pipe and the second inlet pipe includes an inner pipe of the double pipe.

12. The ejector-type refrigeration cycle according to claim 6, wherein
the ejector-type refrigeration cycle is applied to a vehicle air conditioning apparatus,
the first evaporator performs a heat exchange between the liquid-phase refrigerant separated by the first gas-liquid separation portion and a front-seat side blown air to be blown toward a vehicle front seat, and
a length of the first suction pipe is equal to or lower than 10 meters.
